(19) United States
(12) Patent Application Publication
(10) Pub. No.: US 2013/0145147 A1
(43) Pub. Date: Jun. 6, 2013

(54) Content Protection Method

(71) Applicant: Louis Neau, Chateaugiron (FR)

(72) Inventor: Louis Neau, Chateaugiron (FR)

(73) Assignee: VIACCESS, Paris La Defense Cedex (FR)

(21) Appl. No.: 13/811,254

(22) PCT Filed: Jul. 19, 2011
(86) PCT No.: PCT/EP2011/062368

§ 371 Date: Jan. 18, 2013

(30) Foreign Application Priority Data
Jul. 22, 2010 (FR) 10 56000

(51) Int. Cl. H04L 9/08

(52) U.S. Cl. CPC H04L 9/08
USPC 713/153

(57) ABSTRACT

A method for protecting content to be distributed to a pool of receiving terminals connected to a content distribution network and each having a specific security level depending on the technical securing means used, the method comprising the following steps:
when sending,
   generating a key for scrambling said content,
   transforming said scrambling key using a first calculation module 26 arranged at the headend of said content distribution network,
   scrambling the content using the transformed key,
   transmitting the scrambled content and the scrambling key to the terminals, and,
   upon reception of said content and of the scrambling key by a terminal,
   transforming said scrambling key using a second calculation module arranged in said terminal,
   descrambling the content with the transformed scrambling key,
the method also characterized by the steps consisting of,
when sending,
   applying to said scrambling key, by means of said first calculation module, a function F defined according to the specific security level, and when receiving,
   applying to said scrambling key, by means of said second calculation module, a function F defined according to the specific security level.

### TECHNICAL FIELD

The invention pertains to the field of content protection and concerns more specifically a method for protecting a content to be provided to a pool of receiving terminals connected to a content distribution network each terminal having a specific level of security depending on the technical securing means used. The method according to the invention more specifically aims at conditioning the descrambling of said content to a predetermined security level and comprises the following steps:

At transmission,

generating a key for scrambling said content,

transforming said scrambling key using a first calculation module arranged at the headend of said content distribution network,

scrambling the content using the transformed key,

transmitting the scrambled content and the scrambling key to the terminals, and,

on reception of said content and of the scrambling key by a terminal,

transforming said scrambling key using a second calculation module arranged in said terminal,

descrambling the content with the transformed scrambling key.

The method according to the invention is implemented by means of a device comprising:

means for generating a scrambling key for said content,

means for transforming said scrambling key using a first calculation module arranged at the headend of said content distribution network,

means for scrambling the content using the transformed key,

means for transmitting the scrambled content and the scrambling key to the terminals, and,

means for transforming said scrambling key using a second calculation module arranged in said terminal,

means for descrambling the content using the transformed scrambling key.

The invention also relates to a terminal for receiving distributed content scrambled by means of a scrambling key transformed by the method according to the invention.

The invention also relates to a computer program stored in a recording medium and intended, when executed by a computer, to implement the method according to the invention.

### PRIOR STATE OF THE ART

The increasing growth in the rate of data transmission over the Internet offers service operators new outlooks for the distribution of audiovisual content.

Today, particularly in the IPTV market, many service operators aspire to provide the same MPEG2-TS content, to both PC type receiving terminals and conventional decoder-equipped STB (set-top box) terminals. Under these circumstances the DVB-CSA standard (for Digital Video Broadcasting-Common Scrambling Algorithm) is seen as an impediment to the development of services on new terminals, because unlike the AES (Advanced Encryption Standard) for example, it requires a matching hardware element for descrambling content (for example a DVB-CSA descrambler), typically a USB key. The AES standard is thus considered alternative to the DVB-CSA standard for protecting paid content.

One of the risks is to see a segmentation or verticalization of the market according to the algorithms implemented by each for the different actors which may result in a loss of interoperability to the detriment, in the long term, of the service operators themselves.

Further, service operators are required to satisfy the security requirements imposed by programs providers. Indeed, the later may require that certain content or content qualities, such as for example programs distributed in HD (High Definition) quality, not be accessible on low-security terminals such as PCs for example.

In addition, the scrambling algorithms usable for the protection of MPEG2-TS content are potentially numerous and tend to vary depending on the terminals targeted by the service operator. This can lead to additional complexity and cost, particularly for the service operator, with regard to the demands of rights holders and industry interests.

If a single scrambling algorithm were adopted so as to be able to target all terminals, it would have to be based on a software implementation, typically an AES implementation. Rights holders, however, wish, depending on the content type, to differentiate between terminals having available a combination of several technical means of securing content, typically hardware, and the others, in order to avoid endangering their business model.

In the latter case, a solution to this problem consists of discriminating between terminals, such that those which do not have required technical securing means do not have access to protected content. This solution can bring about blackout periods, unless multiple content distribution channels are offered that take into consideration the diversity of receiving terminals.

One goal of the invention is to allow service operators to use a single solution for scrambling distributed content that is adaptable to receiving terminals having different specific levels of security.

The specific security level of a terminal is defined by the technical means implemented in the receiving terminal. Thus, a terminal provided with a USB key for the purpose of descrambling content will have a different security level from that of a PC terminal in which the descrambling of content is achieved solely by software.

For better understanding of the terminology specific to the field of CAS and DRM techniques, the reader can for example refer to the following documents:
regarding conditional access systems, “Functional Model of Conditional Access Systems,” EBU Review, Technical European Broadcasting Union, Brussels, BE, No. 266, 21 Dec. 1995;
regarding digital rights management systems, “DRM Specification,” Open Mobile Alliance OMA-TS-DRM-DRM-V2_{—}0_{—}2-20080723-A, Approved version 2.0.2—23 Jul. 2008.

To simplify understanding of the invention, we will use the generic term “DRM Agent” for:
the CAS or DRM components at the network headend providing license construction or ECM protecting the key to the scrambled content, and associating therewith the terms pertaining to content access;
the CAS or DRM components in the terminals providing access to licenses or the ECM protecting the key to the scrambled content and monitoring access to that key according to the terms pertaining to content access.

### DESCRIPTION OF THE INVENTION

The invention therefore provides a method for protecting content to be distributed to a pool of receiving terminals connected to a content distribution network, each terminal having a specific security level depending on the technical means used for securing them.

The method comprises the following steps:

at transmission,

applying to said scrambling key, by means of said first calculation module, a function F defined according to the specific security level, and at reception,

applying to said scrambling key, by means of said second calculation module, a function F defined according to said specific security level.

According to the invention, said first and second calculation modules each comprise one or more transformation functions Fi for said scrambling key, each function Fi corresponding to a given security level Ni.

The technical securing means defining the security levels Ni relating to the functions Fi are either software or hardware and include at least one of the following features in the terminal:

storage of the scrambling key in encrypted form in a non-volatile memory of the terminal,

storage of the application code of the terminal in encrypted form in a non-volatile memory of the terminal,

loading into a volatile memory of said terminal of the encrypted application code when it is executed,

obfuscation of said code.

According to the invention, by first and second calculation module is meant any hardware or software component implementing the functions F or Fi during transmission at the network headend and upon reception at the terminal, respectively.

Preferably, the scrambling key is transmitted to the terminal encrypted by means of an ECM or other license, and application of the function F to the scrambling key is controlled by the operator via PMT (Program Mapping Table) signaling.

In the case where several security levels Ni are defined, the PMT information indicates whether a function Fi is to be applied and, if so, its identification.

In a preferred embodiment of the method according to the invention, said first calculation module comprises several function Fi for transforming said scrambling key, each function Fi corresponding to a given security level Ni, varying between a minimum security level and a maximum security level corresponding to the specific security level of the terminal.

By way of example, the function F is a one-way function such as the encryption of a key using an AES or TDES algorithm, with the key itself as the encryption key.

In a particular application of the method according to the invention, the content to be distributed is a digital stream comprising a base component requiring the minimum security level and at least one additional component requiring a higher level of security. In such a case, the scrambling of the content by the transformed scrambling key is applied either globally to all components of the stream or selectively to each component of the stream.

The method according to the invention is implemented by a device for sending content to be distributed to a pool of receiving terminals (4, 8, 70), connected to a content distribution network, each having a specific security level depending on the technical securing means employed, the device comprising a scrambling key generator (16) for said content, a content scrambler using the transformed key, means for transmitting the scrambled content and the scrambling key to the terminals; this device also comprising one or more function Fi for transforming said scrambling key K, each function Fi corresponding to a given security level Ni.

The method according to the invention applies to a content receiving terminal belonging to a pool of receiving terminals connected to a content distribution network and each having a specific security level depending on the technical securing means used, said content being distributed in scrambled form by means of a key previously transformed by a first calculation module arranged at the network headend. The terminal according to the invention comprises a second calculation module designed to apply to said scrambling key a transformation allowing recovery of the transformed key used in transmission for scrambling the transmitted content.

This terminal comprises a computer program stored on a recording medium and comprising instructions for carrying out, when it is executed by a computer, the steps of the method according to the invention.

The method according to the invention is implemented when sending by means of a computer program stored on a recording medium and comprising instructions for calculating, when they are executed by a computer, a scrambling key transformed by a function F.

In addition, on the receiving side, the method according to the invention is implemented by a computer program stored on a recording medium and comprising instructions for recovering, when they are executed by a computer, the scrambling key transformed during sending by said function F.

### BRIEF DESCRIPTION OF DRAWINGS

Other features and advantages of the invention will appear from the description which follows, made by way of example and without limitation, with reference to the appended figures in which:

FIG. 1 illustrates schematically a distribution architecture for protected content implementing the method according to the invention,

FIG. 2 illustrates schematically an example of application of the method according to the invention in the case of protected content distributed using adaptive streaming.

### DETAILED DESCRIPTION OF PARTICULAR EMBODIMENTS

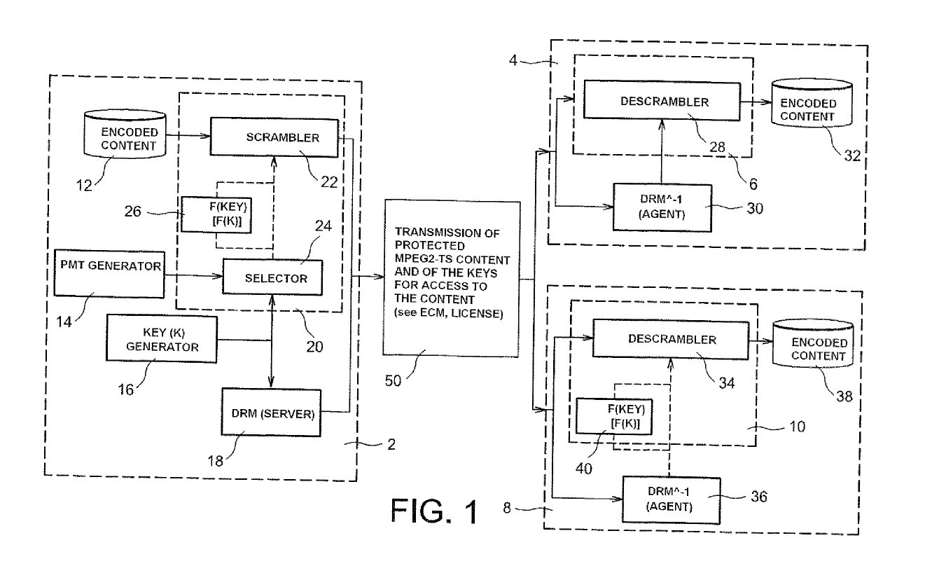

FIG. 1 illustrates schematically a distribution architecture for protected content comprising a platform 2 for conditioning the content to be distributed arranged at the network headend, a first receiving terminal 4 equipped with a descrambling module 6 with a low level of security, and a second receiving terminal 8 equipped with a descrambling module 10 with a higher security level compared with that of the first receiving terminal 4. The platform 2 also comprises a memory 12 designed for storing the content to be distributed, a PMT (Program Mapping Table) signaling generator 14, a scrambling key generator 16, a DRM (Digital Rights Management) agent 18, and a scrambling module 20 comprising a scrambler 22, a scrambling key selector 24, and a first calculation module 26 comprising several functions Fi for transforming said scrambling key, each function Fi corresponding to a given security level Ni specific to one of the receiving terminals 4, 8.

The first receiving terminal 4 also comprises a descrambler 28, a DRM agent 30 and a memory 32 designed for storing content in descrambled form, and a second calculation module 40 comprising the functions Fi for transforming said scrambling key, each function Fi corresponding to a given security level Ni.

In operation, at the transmission side, the generator 14 generates a scrambling key K for the content to be distributed, transmits the generated scrambling key K to the DRM agent 18 for scrambling the content using the key K.

The PMT (Program Mapping Table) signaling generator 14 transmits to the scrambling key selector 24 the identification of a function F to be applied to the key K to transform it prior to scrambling the content. The function F is defined according to the specific security level of the descrambling module of the receiving terminal intended to receive the content.

After application of the function F to the key K, the first calculation module 26 supplies the scrambler 22 a transformed key F(K) which will be used to scramble the content. The scrambled content is then supplied to a transmission module 50 to be transmitted to the terminals 4 and 8. The scrambling key is also transmitted, in encrypted form, to the terminals by means of an ECM or a license.

On the receiving side, the terminal 4, not having a module for calculating the function F, will not be able to generate the transformed key F(K) which was used to scramble the content at the network headend. Consequently, the descrambler 6 will not be able to descramble the content received. The terminal 8, on the other hand, having a second calculation module 40, will be able, after receiving the PMT signal allowing identification of the function F used by the first calculation module 26, to generate the transformed key F(K) and descramble the content using this transformed key.

It should be noted that said first and second calculation modules 26 and 40 are each programmed to apply several functions Fi for transforming said scrambling key which depend on the technical means of securing the content receiving terminals and vary between a minimum level of security and a maximum level of security.

Thus each function Fi is assigned by programming a given security level Ni, this security level Ni taking into consideration the following technical securing means, given as a non-limiting example:

possibility of storing the scrambling key in encrypted form in a non-volatile memory of the terminal,

possibility of storing the terminal's application code in encrypted form in a non-volatile memory of the terminal,

possibility of loading the encrypted application code into a volatile memory of said terminal when it is executed,

possibility of obfuscating said code.

For example, the specific security level of a terminal can be quantified according to the table below:

| Technical | | | | | |
|---|---|---|---|---|---|
| means of | Yes/No | Model A | Model B | Model C | Model D |
| securing | level | Terminal | Terminal | Terminal | Terminal |
| Chipset level | 50/0 | Yes: 50 | No: 0 | Yes: 50 | No: 0 |
| CW* | | | | | |
| protection | | | | | |
| Encrypted | 15/0 | Yes: 15 | Yes: 15 | No: 0 | No: 0 |
| code in | | | | | |
| non-volatile | | | | | |
| memory | | | | | |
| Encrypted | 30/0 | No: 0 | No: 0 | No: 0 | No: 0 |
| code in | | | | | |
| volatile | | | | | |
| memory | | | | | |
| (RAM) on | | | | | |
| execution | | | | | |
| Obfuscation | 05/0 | No: 0 | Yes: 5 | Yes: 5 | No: 0 |
| of code | | | | | |
| Specific | Max level | 65 | 20 | 55 | 0 |
| security level | 100 | (high | (moderate | (boosted | (low level) |
| (Ni) (Sum | | level) | level) | level) | |
| Total) | | | | | |

In the example given in the table above, it is understood that the specific security level of a terminal varies from 0 to 100 depending on the partial or complete presence of technical securing means. Therefore, the first and second security modules can be assigned as many functions Fi as there are specific security levels Ni (16 different levels in the present case).

In the example of FIG. 1, the terminal 4 has a security level which is defined by the fact that the only means used for descrambling content is software consisting of the DRM agent 30, while the terminal 8 has a security level defined by the fact that, in addition to the software consisting of the DRM agent 36, the descrambler 34 includes the second calculation module 40 which is programmed to apply the function F for transforming the key K. The generation of the function F is controlled from the network headend, by the platform 2 by means of PMT signaling transporting a description of the function F used at the network headend, by the first calculation module 26, to generate the transformed key F(K).

In one implementation example, said function F is a one-way function, that is a function which is difficult to invert. A first possibility for the function F is to use an encryption algorithm such as AES or TDES for encrypting K with K as a key. Any other one-way function is suitable, such as a ‘Rabin function’ for example or a MAC calculation function such as ‘SHA 256’.

To avoid pirate copying of the function F by way of software, a function is preferred for F the calculation whereof by software executed by a conventional microprocessor (for PC or Set-Top Box) will take a long time (10 seconds, which corresponds to one cryptoperiod, for example) compared to the same function executed by a specialized hardware component (Digital Signal Processor, Digital Logic Array) exclusive to the terminals having the calculation module and thanks to which the function F will be executed instantaneously (typically a few tens of milliseconds). With this in mind, to exploit the difference in performance, examples of previously mentioned one-way functions can be used for F, stringing together a large number of successive iterations (for example a string of 10000 SHA256 operations on the last result obtained).

The content to be distributed is for example a digital stream comprising a base component having the minimum security level and at least one additional component having the high security level. In this case, the scrambling of the content using the transformed scrambling key is applied either globally to all the components of the stream, or selectively to each component of the stream.

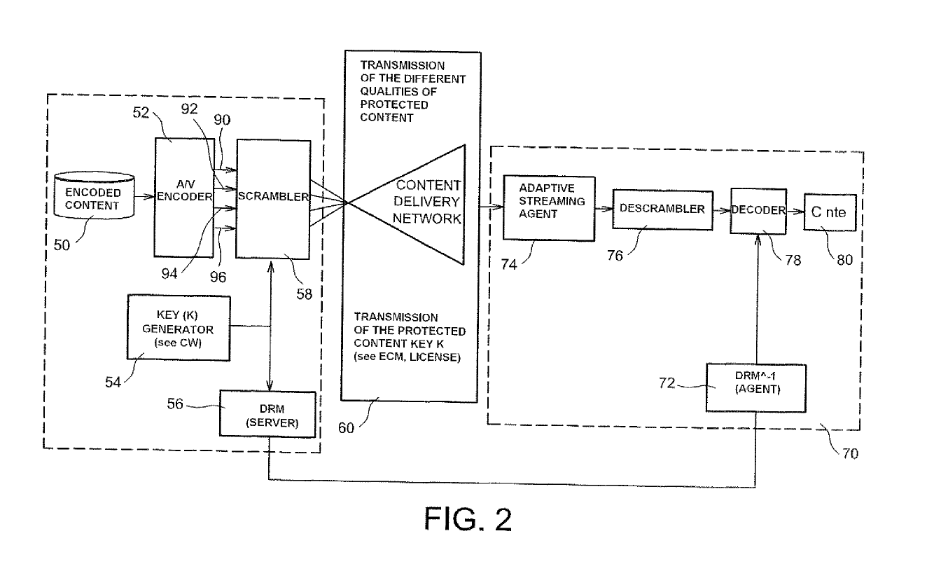

FIG. 2 illustrates an architecture intended to apply the method according to the invention to a stream in the context of adaptive streaming.

In this architecture, the platform 2 for conditioning the content to be distributed comprises a memory 50 for storing the content to be distributed, an A/V encoder 52, a scrambling key generator 54, a DRM agent 56 and a scrambler 58. The platform 2 communicates with a multiplexer 60 designed to transmit content to a terminal 70. The latter comprises a DRM agent 72, a stream adaptation module 74, a descrambler 76, a decoder 78, and a memory 80 for storing the content received.

On the transmission side, content to be distributed, supplied by the memory 50, is conditioned by the encoder 52 so as to deliver four distinct streams transporting the same content, for example, for throughputs of 300 Kbit/s, 700 Kbit/s, 1.5 Mbit/s, and 4 Mbit/s respectively, a quality level and a conditioning security level are associated with each throughput, which are used for coding the transformation function F.

It should be noted that application of the method according to the invention 90, 92, 94, and 96 to adaptive streaming necessitates synchronization of the scrambling keys to the streams associated with the different qualities of the same content, this in order to be able to switch from one quality to the other, typically depending on the throughput available to the user, without impact on the continuity of the service provided.

In operation, the scrambler 58 supplies the streams 90, 92, 94, and 96 to the multiplexer 60 and the DRM agent 56 of the platform 2 provides the encryption key K to the DRM agent 72 of the terminal 70. The streams 90, 92, 94, and 96 then transmitted by the multiplexer 60 to the stream adaptation module 74 which transmits them to the descrambler 76. The descrambler 76 is programmed to descramble the stream(s) having a given throughput according to the type of receiving terminal 70 and/or the content access rights acquired by that terminal. Thus, a terminal will receive the content with one of the throughputs, 300 Kbit/s or 700 Kbit/s or 1.5 Mbit/s, or 4 Mbit/s. The content thus unscrambled is either viewed or stored in the memory 80 depending on the access rights associated with the terminal 70.

1. A method for protecting content to be distributed to a pool of receiving terminals connected to a content distribution network and each having a specific security level depending on the technical securing means used, the method comprising the following steps:
at transmission,
generating an scrambling key K for said scrambling content,
transforming said scrambling key K using a first calculation module arranged in the headend of the content distribution network,
scrambling the content using the transformed key,
transmitting the scrambled content and the scrambling key to the terminals, and,
upon reception of said content and of the scrambling key by a terminal,
transforming said scrambling key using a second calculation module arranged in said terminal,
descrambling the content using the transformed scrambling key,
the method also being characterized by the steps consisting of,
when transmitting,
applying to said scrambling key K, by means of said first calculation module, a function F defined according to said specific security level, and at reception,
applying to said scrambling key, by means of said second calculation module, a function F defined according to said specific security level.

2. A method according to claim 1 in which said first calculation module and said second calculation module each include several functions Fi for transforming said scrambling key K, each function Fi corresponding to a given security level Ni.

3. A method according to claim 1 wherein said technical securing means are either software or hardware.

4. A method according to claim 3 in which said securing means comprise at least one of the following features:
storage of the scrambling key in encrypted form in a non-volatile memory of the terminal,
storage of the application code of the terminal in encrypted form in a non-volatile memory of the terminal,
loading into a volatile memory of said terminal of the encrypted application code when it is executed,
obfuscation of said code.

5. A method according to claim 1 wherein the scrambling key K is transmitted, in encrypted form, to the terminals via an ECM or a DRM (Digital Rights Management) license.

6. A method according to claim 1 wherein the application of the function F to the scrambling key K is controlled by the operator via PMT (Program Mapping Table) signaling.

7. A method according to claim 2 wherein said second calculation module includes several functions Fi for transforming said scrambling key, each function Fi corresponding to a given security level Ni varying between a minimum security level and a maximum security level corresponding to the specific security level of the terminal.

8. A method according to claim 7 wherein said function F is a one-way function.

9. A method according to claim 1 wherein the content to be distributed is a digital stream comprising a base component having the minimum security level and at least one additional component having a higher security level.

10. A method according to claim 9 wherein the scrambling of the content by the transformed scrambling key is applied either globally to all components of the stream or selectively to each component of the stream.

11. Application of the method according to claim 10 to a stream in an adaptive streaming context wherein the function F is applied to the higher-quality components of the stream.

12. A device for sending content to be distributed to a pool of receiving terminals, connected to a content distribution network and each having a specific level of security depending on the technical securing means used, the device comprising a generator of keys for scrambling said content, a content scrambler using the transformed key, means for transmitting the content and the scrambling key to the terminals, the device characterized in that it also includes one or more functions Fi for transforming said scrambling key K, each function Fi corresponding to a given security level Ni.

13. A content receiving terminal belonging to a pool of receiving terminals connected to a content distribution network and each having a specific security level depending on the technical means of securing used, said content being distributed in scrambled form by means of a scrambling key previously transformed by a first calculation module arranged at the network headend, said key being transmitted to said terminal, characterized in that it comprises a second calculation module designed to apply to said scrambling key a transformation allowing recovery of the transformed key used in sending to scramble the transmitted content.

14-15. (canceled)
